(19) United States
(12) Patent Application Publication
(10) Pub. No.: US 2020/0103055 A1
(43) Pub. Date: Apr. 2, 2020

(54) Wireline Lubricator Support Clamp

(71) Applicant: Hunting Titan, Inc., Pampa, TX (US)

(72) Inventor: Keith Henderson, The Woodlands, TX (US)

(73) Assignee: Hunting Titan, Inc., Pampa, TX (US)

(21) Appl. No.: 16/500,732

(22) PCT Filed: Apr. 13, 2018
(86) PCT No.: PCT/US18/27586

§ 371 Date: Oct. 3, 2019

Related U.S. Application Data
(60) Provisional application No. 62/484,980, filed on Apr. 13, 2017.

(51) Int. Cl. F16L 3/22; E21B 33/03; E21B 41/00; F16L 3/10

(52) U.S. Cl. CPC F16L 3/222; F16L 3/1091; E21B 41/00; E21B 33/03

(57) ABSTRACT

A support clamp for clamping different sized lubricator or oilfield tubulars to allow for laying down lubricator tubular assemblies during rig up and rig down operations.

### RELATED APPLICATION

This application claims priority to U.S. Provisional Application No. 62/484,980, filed Apr. 13, 2017.

### BACKGROUND OF THE INVENTION

Generally, when completing a subterranean well for the production of fluids, minerals, or gases from underground reservoirs, several types of tubulars are placed downhole as part of the drilling, exploration, and completions process. These tubulars can include casing, tubing, pipes, liners, and devices conveyed downhole by tubulars of various types. Each well is unique, so combinations of different tubulars may be lowered into a well for a multitude of purposes.

A subsurface or subterranean well transits one or more formations. The formation is a body of rock or strata that contains one or more compositions. The formation is treated as a continuous body. Within the formation hydrocarbon deposits may exist. Typically a wellbore will be drilled from a surface location, placing a hole into a formation of interest. Completion equipment will be put into place, including casing, tubing, and other downhole equipment as needed.

A lubricator, which may include a long high-pressure pipe fitted to the top of a wellhead or Christmas tree, allows tools to be placed into a high-pressure well. The top of the lubricator assembly may include a high-pressure grease injection section and sealing elements. The lubricator may be installed on top of the wellhead, the tools may be then placed within the lubricator, and then the lubricator may be pressurized to the wellbore pressure. Valves on top of the wellhead may be opened to enable the one or more tools placed within the lubricator to fall or pump downhole into the wellbore while maintaining wellbore pressure. Once the designed tasks are performed, the one or more oilfield tools may be removed by bringing the tools into the lubricator, closing the valves at the wellhead, bleeding off the pressure in the lubricator, and then opening the lubricator to retrieve the tools therein.

Lubricators are often associated with well workover and intervention. The lubricator may include the assembly of pressure control equipment used in slickline operations or some other downhole conveyance method to house the tool string in preparation for running the tool string into the well. The lubricator assembly is also used to remove a tool string after operations. The lubricator may include an assembly of sections of heavy wall tube which may include integral seals and connections. Lubricator sections are routinely used on the assembly of pressure control equipment for other well intervention operations including, but not limited to, coiled tubing operations. Tool strings may include a variety of downhole tools coupled together, including, but not limited to, perforating guns, packers, setting tools, sampling tools, pressure testing tools, and logging tools in general.

### SUMMARY OF EXAMPLE EMBODIMENTS

An example embodiment may include an apparatus for supporting oilfield tubulars comprising a first rectangular piece defined by a height, width, thickness and a concave cutout extending from a first face to a second face, centered on the edge of the height and thickness which defines the inner edge, wherein the height is greater than the width and the width is greater than the thickness, the first face and second face are defined by the height and width, separated by the thickness, a second rectangular piece defined by a height, width, thickness and a concave cutout extending from a first face to a second face, centered on the edge of the height and thickness which defines the inner edge, wherein the height is greater than the width and the width is greater than the thickness, the first face and second face are defined by the height and width, separated by the thickness, and wherein the first rectangular piece coupled to the second rectangular piece forms a clamp using the inner edge of both rectangular pieces becoming substantially aligned with the thickness of both rectangular pieces substantially coplanar, the two circular cutouts forming a circular hole adapted to fit a tubular of a predetermined diameter.

A variation of the example embodiment may include at least one thru hole parallel extending from the first face to the second face of the first rectangular piece and located between the concave cutout and the edge opposite of the inner edge. It may include at least one thru hole parallel extending from the first face to the second face of the second rectangular piece and located between the concave cutout and the edge opposite of the inner edge. It may include a non-marking material lining the inner radii of the concave portions. The clamp may be mechanically fastened by inserting at least two threaded fastener through the first rectangular piece and threaded it into the second rectangular piece. The at least one thru hole may be a plurality of thru holes aligned with the edge opposite of the inner edge. The plurality of thru holes may be adapted for mechanically fastening the tubular to a support frame. The plurality of thru holes may be adapted for mechanically fastening the clamp composed of the first rectangular piece and the second rectangular piece to a second clamp. The plurality of thru holes may be adapted for passing control lines through the clamp, parallel with the tubular. The tubular may be a heavy walled oilfield lubricator tubular.

An example embodiment may include a support clamp for holding a cylindrical tubular comprising a first and second clamp half, each having a comparable height, width, and thickness, both halves having a first and second concave region for receiving a cylindrical portion of a tubular, a threaded fastener passing through the first clamp half and mechanically fastened into the second clamp half above and tangentially offset from the first and second concave region for selectively drawing the clamp halves toward one another and the concave regions into engagement with the tubular, and wherein the first and second clamp halves form a substantially square shaped clamp that attaches proximate to the end of a tubular of a predetermined size.

A variation of the example embodiment may include the mechanically fastener having a threaded fastener passing through the first clamp half and mechanically fastened into the second clamp below and tangentially offset from the first and second concave region. At least one through hole may pass through the first face and the second face of the combined clamp located between the first concave region and the first edge. It may include a non-marking material forming an integral part of the first and second concave regions.

An example embodiment may include a method for stacking tubulars comprising clamping a first rectangular clamping means onto a portion of a tubular proximate to one end of the tubular, clamping a second rectangular clamping means onto a portion of a tubular proximate to a second end of the tubular, clamping a third rectangular clamping means onto a portion of a tubular proximate to one end of the tubular, champing a fourth rectangular clamping means onto a portion of a tubular proximate to a second end of the tubular, and stacking the first tubular on the second tubular, wherein the first rectangular clamping means is positioned on top of the third rectangular clamping means and the second rectangular clamping means is positioned on top of the fourth rectangular clamping means.

A variation of the example embodiment may include the clamping means being a first rectangular piece defined by a height, width, thickness and a concave cutout extending from a first face to a second face, centered on the edge of the height and thickness which defines the inner edge, wherein the height is greater than the width and the width is greater than the thickness, the first face and second face are defined by the height and width, separated by the thickness, a second rectangular piece being defined by a height, width, thickness and a concave cutout extending from a first face to a second face, centered on the edge of the height and thickness which defines the inner edge, wherein the height is greater than the width and the width is greater than the thickness, the first face and second face are defined by the height and width, separated by the thickness, and wherein the first rectangular piece coupled to the second rectangular piece using the inner edge of both rectangular pieces becoming substantially aligned with the thickness of both rectangular pieces substantially coplanar, the two circular cutouts forming a circular hole adapted to fit a tubular of a predetermined diameter.

The clamping means may be a first and second clamp half, each having a comparable height, width, and thickness, both halves having a first and second concave region for receiving a cylindrical portion of a tubular, and a threaded fastener passing through the first clamp half and threaded into the second clamp half above and tangentially offset from the first and second concave region for selectively drawing the clamp halves toward one another and the concave regions into engagement with the tubular, wherein the first and second clamp halves form a substantially square shaped clamp that attaches proximate to the end of a tubular of a predetermined size.

### BRIEF DESCRIPTION OF THE DRAWINGS

For a thorough understanding of the present invention, reference is made to the following detailed description of the preferred embodiments, taken in conjunction with the accompanying drawings in which reference numbers designate like or similar elements throughout the several figures of the drawing. Briefly:

FIG. 1 depicts a cross-sectional side view of an example embodiment.

FIG. 2 is a view of the support clamp connected to a lubricator tubular.

FIG. 3 is a view of the support clamp connected to multiple tubulars of different sizes coupled to each other.

FIG. 4 is a view of the support clamp connected to several tubulars stacked on each other.

### DETAILED DESCRIPTION OF EXAMPLES OF THE INVENTION

In the following description, certain terms have been used for brevity, clarity, and examples. No unnecessary limitations are to be implied therefrom and such terms are used for descriptive purposes only and are intended to be broadly construed. The different apparatus, systems and method steps described herein may be used alone or in combination with other apparatus, systems and method steps. It is to be expected that various equivalents, alternatives, and modifications are possible within the scope of the appended claims.

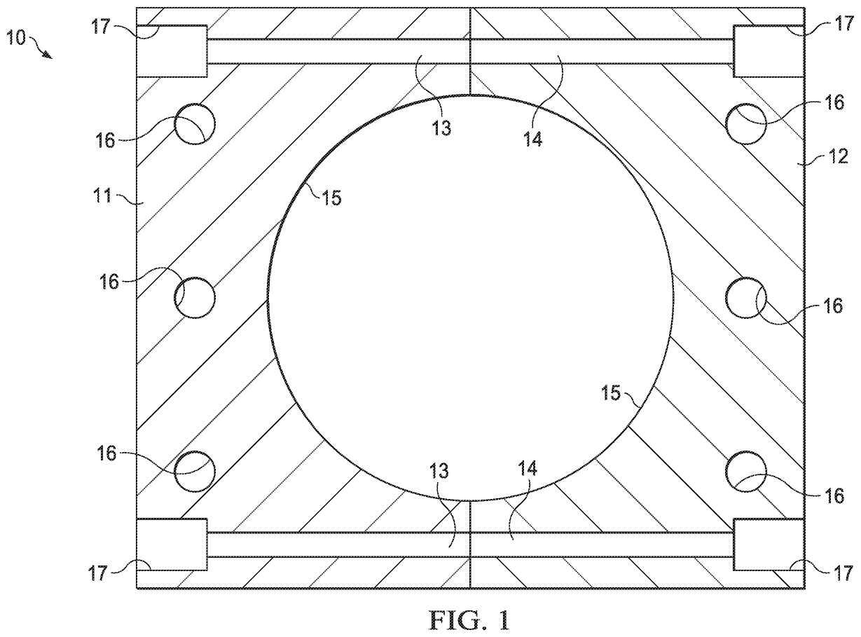

FIG. 1 depicts a lubricator support clamp assembly 10. The assembly includes clamp 11 and clamp 12. Both clamps are the same and interchangeable. The clamp 11 has holes 13 that mate with the thru holes 14 of clamp 12. The thru holes have shoulders 17 for mechanical fasteners, such as clamp screws, that couple the assembly together. Holes 16 provide anchor points to lift, move, or secure the clamps after they have been coupled to a tubular. The clamp 15 is sized to accommodate any size tubular that is found on a lubricator assembly or other similar oilfield tubular. The purpose of the clamp assembly 10 is to provide support for each different tubular component of a lubricator in order to allow the entire assembly to lay flat on a rig floor or work pad during rigging up and rigging down operations.

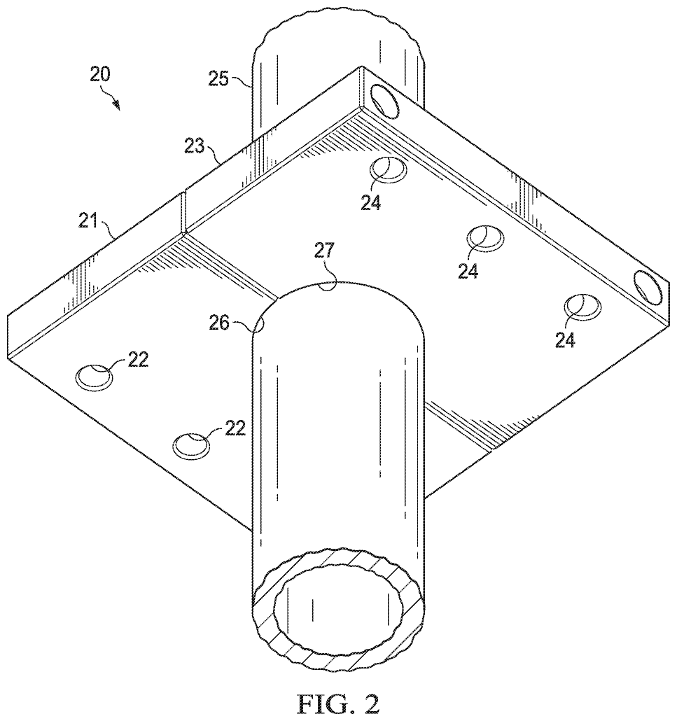

An example embodiment is shown in FIG. 2 where a clamp 20 is clamped onto a lubricator tubular 25. The clamp 20 is composed of two pieces, rectangular clamp piece 21 and clamp piece 23. The holes 22 on clamp piece 21 and holes 24 on clamp piece 23 allow for connecting to brace the clamp 20 and its tubular 25. Concave portion 26 and concave portion 27 clamp around tubular 25. The clamp pieces 21 and 23 are screwed together from the side.

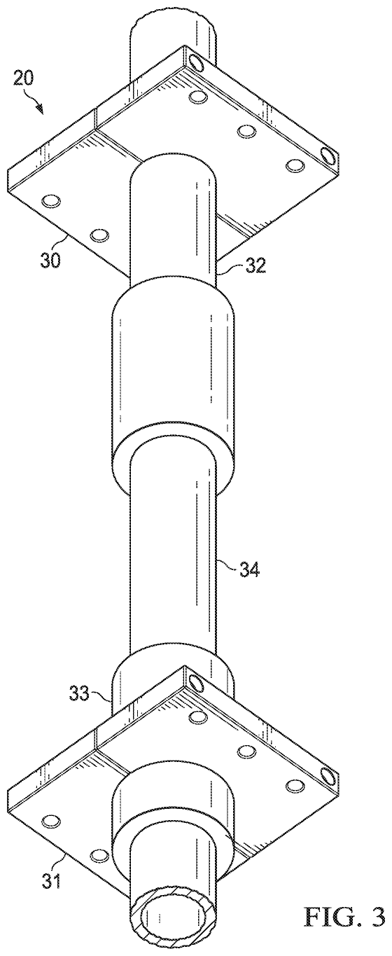

An example embodiment is shown in FIG. 3 where a lubricator tubular assembly 34 first clamp 31 is used in conjunction with a second clamp 30 to brace a lubricator tubular 32 and 33, which are both couple to each other and both have different diameters. The clamps 30 and 31 allow the lubricator tubular assembly 34 to lie on its side while being properly supported. This allows for more efficient rigging up and rigging down operations when assembling tubulars on a rig.

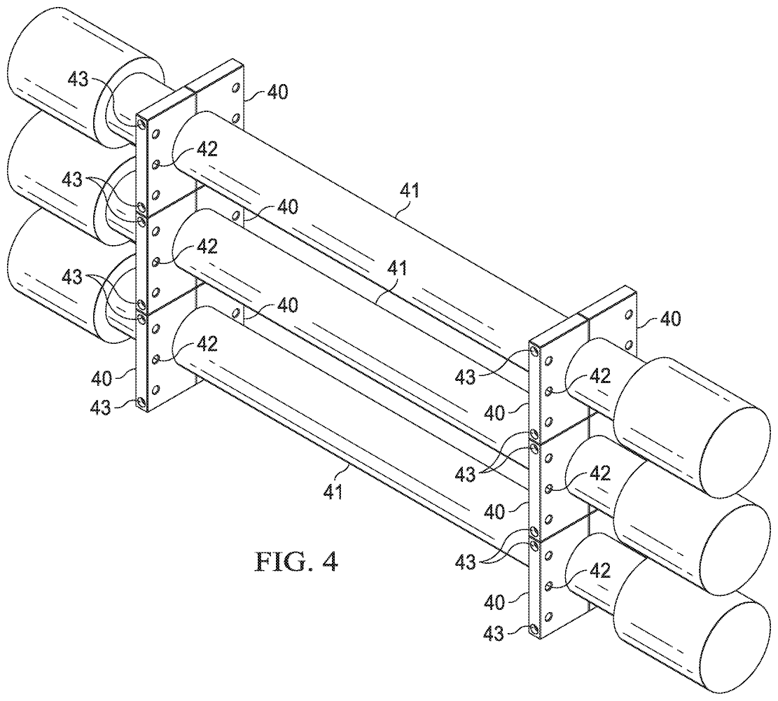

An example embodiment is shown in FIG. 4 where a plurality of tubulars 41 are stacked on top of each other using at least two clamps 40 placed proximate to either end of each tubular 41. This allows for the efficient stacking of tubulars for storage, transport, and rigging operations at a wellsite. The clamps 40 may be mechanically fastened to each other using holes 42. The clamp halves are mechanically fastened together using holes 43.

Although the invention has been described in terms of embodiments which are set forth in detail, it should be understood that this is by illustration only and that the invention is not necessarily limited thereto. For example, terms such as upper and lower or top and bottom can be substituted with uphole and downhole, respectfully. Top and bottom could be left and right, respectively. Uphole and downhole could be shown in figures as left and right, respectively, or top and bottom, respectively. Generally downhole tools initially enter the borehole in a vertical orientation, but since some boreholes end up horizontal, the orientation of the tool may change. In that case downhole, lower, or bottom is generally a component in the tool string that enters the borehole before a component referred to as uphole, upper, or top, relatively speaking. The first housing and second housing may be top housing and bottom housing, respectfully. Terms like wellbore, borehole, well, bore, oil well, and other alternatives may be used synonymously. Terms like tool string, tool, perforating gun string, gun string, or downhole tools, and other alternatives may be used synonymously. The alternative embodiments and operating techniques will become apparent to those of ordinary skill in the art in view of the present disclosure. Accordingly, modifications of the invention are contemplated which may be made without departing from the spirit of the claimed invention.

What is claimed is:

1. An apparatus for supporting oilfield tubulars comprising:
a first rectangular piece defined by a height, width, thickness and a concave cutout extending from a first face to a second face, centered on the edge of the height and thickness which defines the inner edge, wherein the height is greater than the width and the width is greater than the thickness, the first face and second face are defined by the height and width, separated by the thickness;
a second rectangular piece defined by a height, width, thickness and a concave cutout extending from a first face to a second face, centered on the edge of the height and thickness which defines the inner edge, wherein the height is greater than the width and the width is greater than the thickness, the first face and second face are defined by the height and width, separated by the thickness; and
wherein the first rectangular piece coupled to the second rectangular piece forms a clamp using the inner edge of both rectangular pieces becoming substantially aligned with the thickness of both rectangular pieces substantially coplanar, the two circular cutouts forming a circular hole adapted to fit a tubular of a predetermined diameter.

2. The apparatus of claim 1 further comprising at least one thru hole parallel extending from the first face to the second face of the first rectangular piece and located between the concave cutout and the edge opposite of the inner edge.

3. The apparatus of claim 1 further comprising at least one thru hole parallel extending from the first face to the second face of the second rectangular piece and located between the concave cutout and the edge opposite of the inner edge.

4. The apparatus of claim 1 further comprising a non-marking material lining the inner radii of the concave portions.

5. The apparatus of claim 1 wherein the clamp may be mechanically fastened by inserting at least two threaded fasteners through the first rectangular piece and threaded it into the second rectangular piece.

6. The apparatus of claim 3 wherein the at least one thru hole is a plurality of thru holes aligned with the edge opposite of the inner edge.

7. The apparatus of claim 6 wherein the plurality of thru holes is adapted for mechanically fastening the tubular to a support frame.

8. The apparatus of claim 6 wherein the plurality of thru holes is adapted for mechanically fastening the clamp composed of the first rectangular piece and the second rectangular piece to a second clamp.

9. The apparatus of claim 6 wherein the plurality of thru holes is adapted for passing control lines through the clamp, parallel with the tubular.

10. The apparatus of claim 1 wherein the tubular is a heavy walled oilfield lubricator tubular.

11. A support clamp for holding a cylindrical tubular comprising:
a first and second clamp half, each having a comparable height, width, and thickness, both halves having a first and second concave region for receiving a cylindrical portion of a tubular;
a threaded fastener passing through the first clamp half and mechanically fastened into the second clamp half above and tangentially offset from the first and second concave region for selectively drawing the clamp halves toward one another and the concave regions into engagement with the tubular; and
wherein the first and second clamp halves form a substantially square shaped clamp that attaches proximate to the end of a tubular of a predetermined size.

12. The apparatus of claim 11 wherein mechanically fastened include a threaded fastener passing through the first clamp half and mechanically fastened into the second clamp below and tangentially offset from the first and second concave region.

13. The apparatus of claim 11 wherein at least one through hole between the first face and the second face of the combined clamp located between the first concave region and the first edge.

14. The apparatus of claim 11 further comprising a non-marking material forming an integral part of the first and second concave regions.

15. A method for stacking tubulars comprising:
clamping a first rectangular clamping means onto a portion of a tubular proximate to one end of the tubular;
clamping a second rectangular clamping means onto a portion of a tubular proximate to a second end of the tubular;
clamping a third rectangular clamping means onto a portion of a tubular proximate to one end of the tubular;
clamping a fourth rectangular clamping means onto a portion of a tubular proximate to a second end of the tubular; and
stacking the first tubular on the second tubular, wherein the first rectangular clamping means is positioned on top of the third rectangular clamping means and the second rectangular clamping means is positioned on top of the fourth rectangular clamping means.

16. The method of claim 15 wherein the clamping means is a first rectangular piece defined by a height, width, thickness and a concave cutout extending from a first face to a second face, centered on the edge of the height and thickness which defines the inner edge, wherein the height is greater than the width and the width is greater than the thickness, the first face and second face are defined by the height and width, separated by the thickness;
a second rectangular piece defined by a height, width, thickness and a concave cutout extending from a first face to a second face, centered on the edge of the height and thickness which defines the inner edge, wherein the height is greater than the width and the width is greater than the thickness, the first face and second face are defined by the height and width, separated by the thickness; and
wherein the first rectangular piece coupled to the second rectangular piece using the inner edge of both rectangular pieces becoming substantially aligned with the thickness of both rectangular pieces substantially coplanar, the two circular cutouts forming a circular hole adapted to fit a tubular of a predetermined diameter.

17. The method of claim 15 wherein the clamping means is a first and second clamp half, each having a comparable height, width, and thickness, both halves having a first and second concave region for receiving a cylindrical portion of a tubular; and
a threaded fastener passing through the first clamp half and threaded into the second clamp half above and tangentially offset from the first and second concave region for selectively drawing the clamp halves toward one another and the concave regions into engagement with the tubular;
wherein the first and second clamp halves form a substantially square shaped clamp that attaches proximate to the end of a tubular of a predetermined size.
